(19) United States
(12) Patent Application Publication
(10) Pub. No.: US 2020/0276496 A1
(43) Pub. Date: Sep. 3, 2020

(54) VIRTUAL REALITY MOTION PLATFORM

(71) Applicant: Sahiner TUGRA, Istanbul (TR)

(72) Inventor: Sahiner TUGRA, Istanbul (TR)

(21) Appl. No.: 16/331,531

(22) PCT Filed: Oct. 3, 2017
(86) PCT No.: PCT/TR2017/050471

§ 371 Date: Mar. 8, 2019

(30) Foreign Application Priority Data
Oct. 18, 2016 (TR) 2016/14631

(51) Int. Cl. A63F 13/212; A63F 13/211; A63F 13/24; G06F 3/01; G06F 3/0481

(52) U.S. Cl. CPC A63F 13/212; A63F 13/211; G06F 3/04815; G06F 3/012; G06F 3/014; A63F 13/24

(57) ABSTRACT

The present invention is related to a virtual reality motion platform which is developed to provide the body movements and directions such as walking, running jumping, bending/leaning over, etc. to be transferred to the software based simulative environments which are also known as virtual reality environments.

### CROSS REFERENCE TO THE RELATED APPLICATIONS

This application is the national phase entry of International Application No. PCT/TR2017/050471, filed on Oct. 3, 2017, which claims priority from the Turkish patent application no. 2016/14631 filed on Oct. 18, 2016, the entire contents of which are incorporated herein by reference.

### TECHNICAL FIELD

The present invention is related to; a virtual reality motion platform which is developed to provide body movements and directions such as walking, running, jumping, bending, etc. to be transferred to software based simulative environments which are also known as virtual reality environments.

### BACKGROUND

Software based simulative environments which are also known as virtual reality environments and increasingly being a part of the modern world are used in a great range of areas covering computer games, education applications etc.

While it is a significant challenge to create a virtual reality environment in terms of hardware and the software, another critic technical handicap which needs to be eliminated in order to use virtual reality environments effectively is to enable an interaction between a user and a virtual reality environment.

No matter what type of a hardware such as desktop based, console based or a specific hardware developed for a particular aim is used, the interaction between the user and the virtual reality environments is provided by means of the auxiliary equipment including a keyboard, a mouse, a game controller, etc. This leads to a user to perform his/her interaction with the environment with the help of the movements which are allowed by the hardware which he/she uses instead of their natural movements. Limited movements restrict the movement freedom of the users as the most basic principle of the virtual reality environment and cause their experiences to be halted.

Some applications which are separately known in the prior art of the invention from hardware-dependent interaction methods and which can transfer the user movements to a virtual reality environment by tracking are also provided. In said systems, movements of the user are transferred to a virtual reality environment by tracking them via optical sensors (a camera, IR, thermal screening, etc.). At this point, the most important technical problem is that the system would fail to continue tracking and even stop performing upon giving an error if a user gets out of the tracking range of a sensor.

Therefore, a great number of equipment have been developed in the prior art to provide transferring the user movements to virtual reality environments while preserving the most natural states of users. The most prominent examples among the equipment which have been able to find the most common usage area are the motion platforms which enable the user to interact with a virtual reality environment without restricting their movement freedom in a restricted range.

There are many motion platforms which consist of one or more components, which can transfer some specific movements or all body movements of the user to a virtual reality environment. The inventions which are disclosed in some Patent documents such as KR101297753, KR100919616, US2004048722, KR101439175, EP2417508, DE 102008032231, WO2007062238, WO2005084761, U.S. Pat. No. 5,963,891, US2003220763, U.S. Pat. Nos. 6,135,928, 6,052,114, WO2004099967, WO2004099966, WO2004072836, WO9742590, GB2291167, DE19838801 and DE19713805 can be referred to as examples of the motion platforms which are known in prior art.

### SUMMARY

The present invention according to the application, which is developed with the aim of transferring all body movements of the user including specific mechanical features such as their movement directions and magnitudes without limiting their movement freedom to a virtual reality environment in a most sensitive manner while solving the aforementioned technical problems; is related to a motion platform which enables the user to move in all directions without any limitation by getting on a monitoring equipment which can be mounted on a ceiling or a wall and is directly connected to a user by means of a balancing rod therein.

The monitoring equipment can monitor all of the body movements of the user including jumping and bending and the mechanical features such as movement directions and magnitudes and transfer the most accurate motion data to a virtual reality environment.

A motion platform provides the user movement freedom in all directions and the user can freely move in all directions and distances no matter how long the distances are in a virtual reality environment. However, the motion platform can transfer additional information related to the user movements in a similar manner to the monitoring equipment and thereby the most accurate information related to the user movements can be attained.

### BRIEF DESCRIPTION OF THE DRAWINGS

The figures of a virtual reality motion platform according to the present invention are disclosed as follows.

FIG. 1—is an overall view of a virtual reality motion platform.

FIG. 2—is an overall view of a mounting element of the virtual reality motion platform.

FIG. 3—is a side view of the connecting element of the virtual reality motion platform.

FIG. 4—is a sectional view of the connecting element of the virtual reality motion platform.

FIG. 5—is an inside view of the connecting element of the virtual reality motion platform.

FIG. 6—is a front view of the connecting element of the virtual reality motion platform.

FIG. 7—is an overall view of a bottom and a shoe of the virtual reality motion platform.

FIG. 8—is a bottom perspective of the shoe of the virtual reality motion platform.

FIG. 9—is rear view of the shoe of the virtual reality motion platform.

FIG. 10—is an overall view of another embodiment of the virtual reality motion platform.

FIG. 11—is a top view of another embodiment of the bottom of the virtual reality motion platform.

FIG. 12—is a detail view of a ball mechanism placed on the bottom of the virtual reality motion platform.

FIG. 13—is a front view of the virtual reality motion platform with a user and virtual reality glasses.

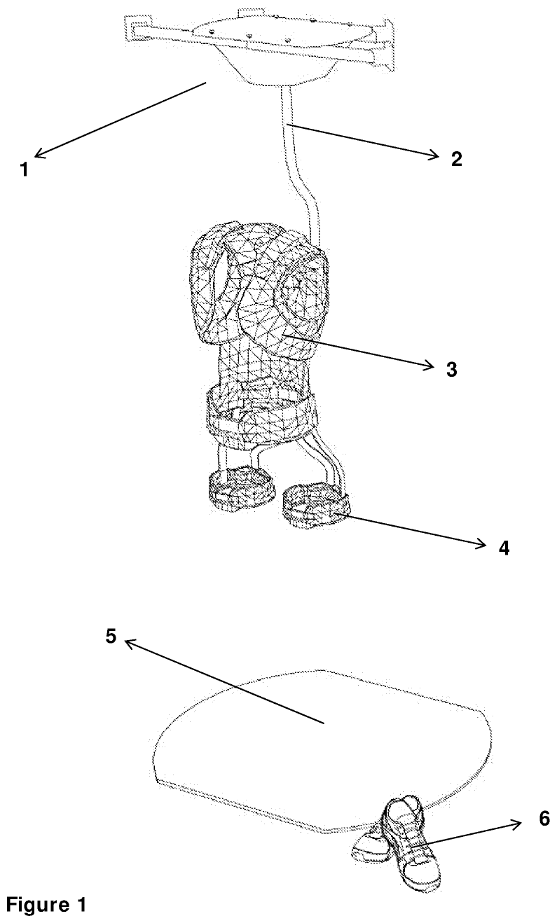

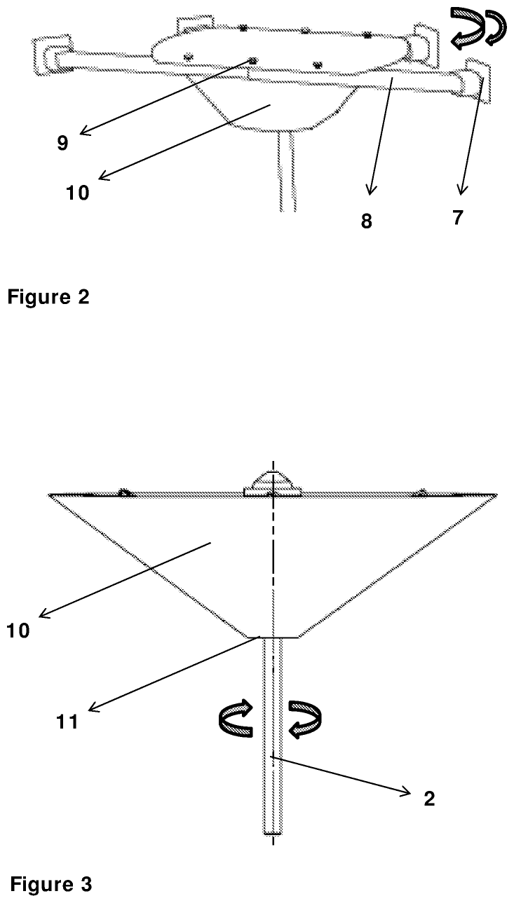

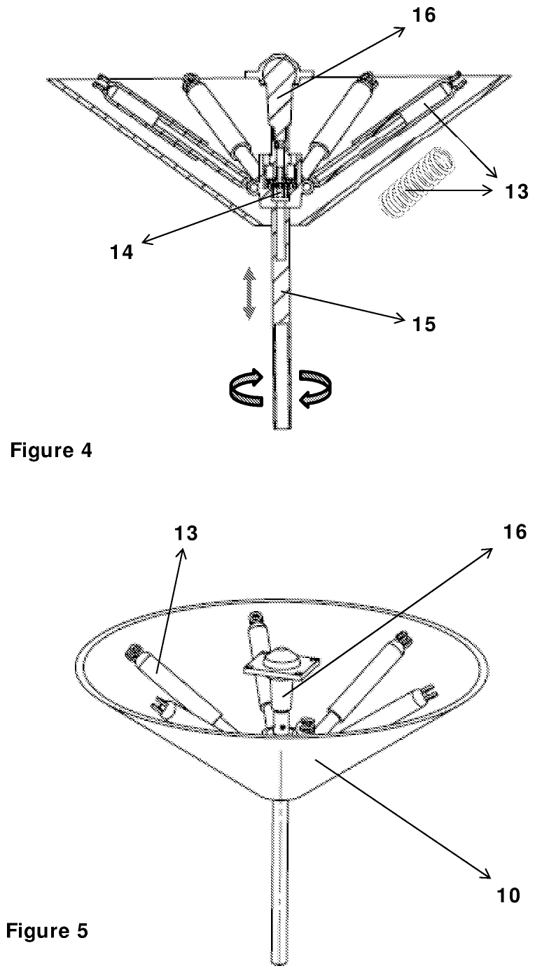

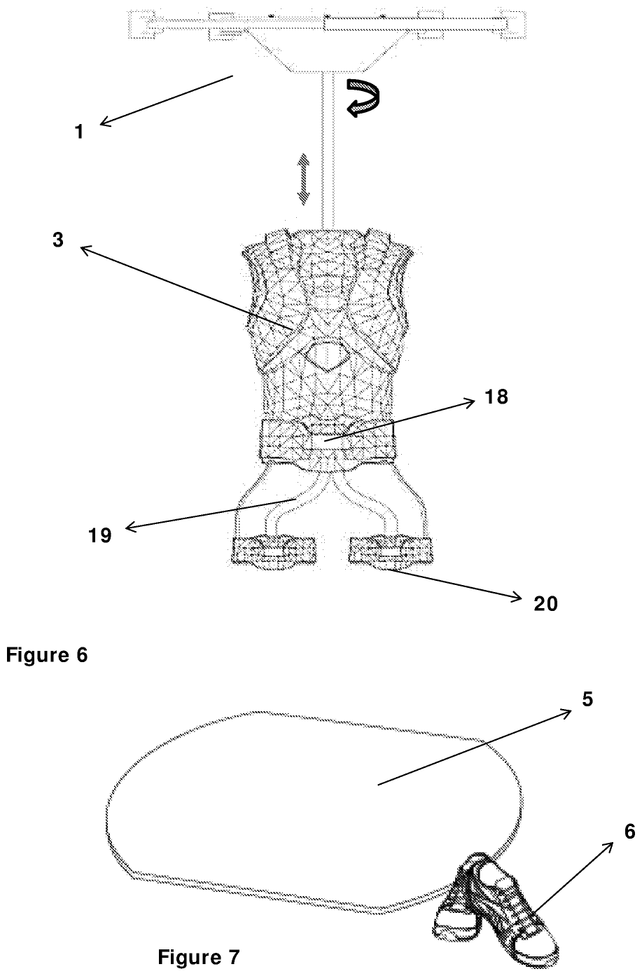

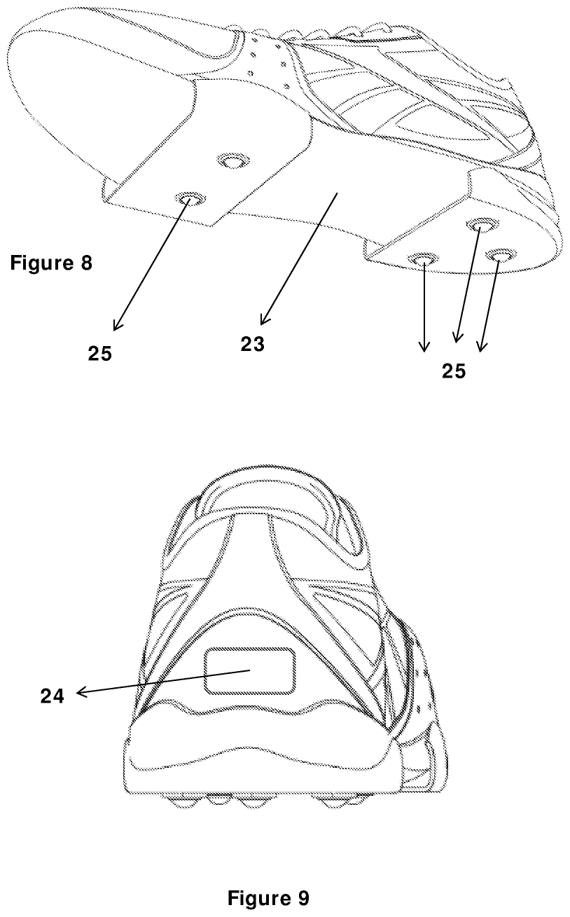

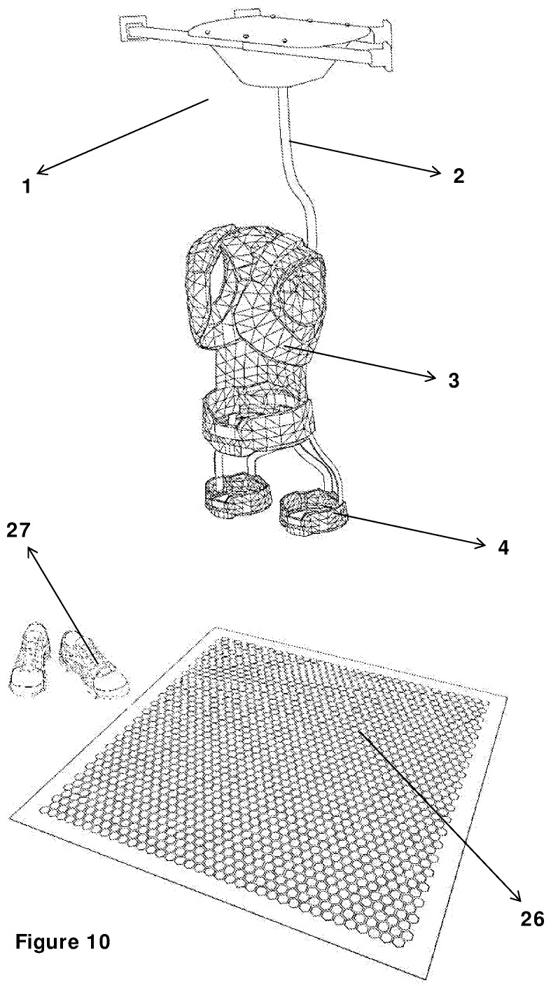

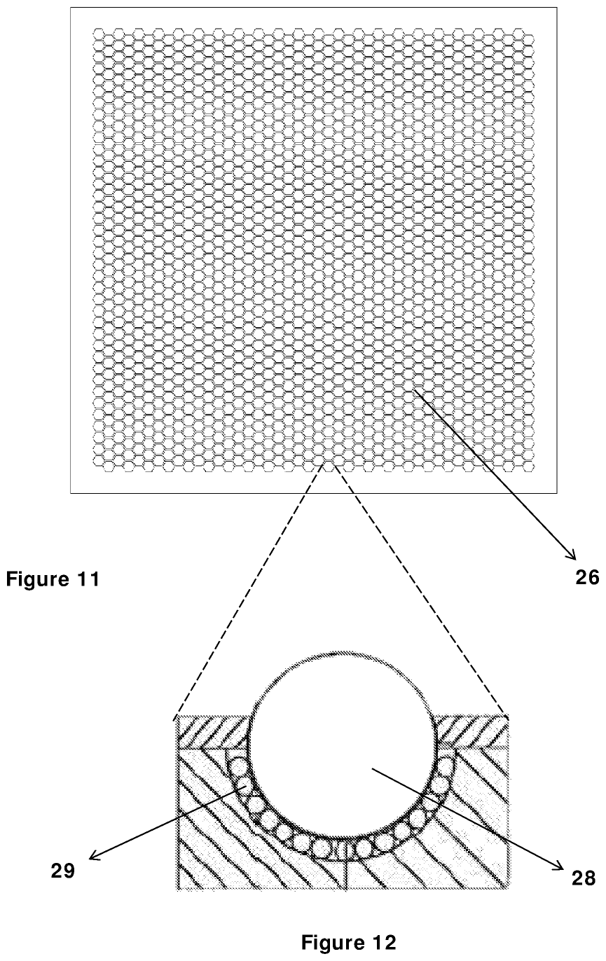

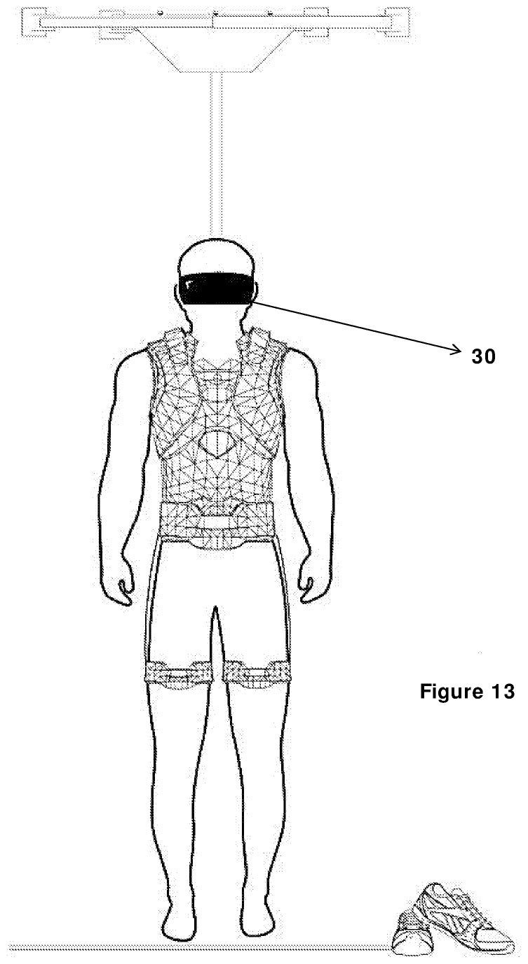

### DESCRIPTION OF THE ELEMENTS/PORTIONS/PARTS OF THE INVENTION

The parts/portions/elements which are illustrated in the appended figures disclosed in order to describe a virtual reality motion platform according to the invention are individually numbered and the description of each number is provided below.
1. Connection apparatus
2. Balancing rod
3. Gaming vest/Harness element
4. Leg belt set
5. High friction coefficient smooth plane floor
6. Shoes with balls
7. Wall mounting apparatus
8. Load drawbar
9. Ceiling mounting apparatus
10. Outer body
11. Movement limiting steel ring
13. Damper system
14. Rotary head
15. Interconnection element
16. Analogue potentiometer and motion system
18. Gaming vest electronic circuit and sensor slot
19. Leg belt
20. Leg belt electronic circuit and sensor slot
23. Foot sole
24. Electronic circuit and sensor slot for the shoes
25. Balls for shoes
26. Ball covered floor
27. Shoes without balls
28. Floor balls
29. Micro bearing ball
30. Virtual reality glasses

### DETAILED DESCRIPTION OF THE EMBODIMENTS

The virtual reality motion platform according to the present invention which is developed to provide body movements and directions such as walking, running, jumping, bending, etc. to be transferred to the software based simulative environments which are also known as virtual reality essentially consists of 3 main parts.

D. Mounting Apparatus (1):

The mounting apparatus (1) is an apparatus which enables a gaming vest/harness (3) to be worn by a user to be mounted on a stable structure such as a wall or a ceiling and also has the electronic and mechanical equipment which can sense, restrict and apply a certain force against the user's movements.

The mounting apparatus (1) may consist of;
A covered outer body (10) including a balancing rod (2), a movement limiting steel ring (11), a damper system (13) being connected to eight different points, a rotary head (14), an interconnection element (15) and an analogue potentiometer and motion system (16),
a plurality of ceiling mounting apparatus (9) providing the outer body (10) to be mounted on a stable structure such as a wall or a ceiling, a plurality of load drawbars (8) and a plurality of wall mounting apparatus (7).

The damper system (13) can be a hydraulic damper system as well as a spring damper system according to different embodiments of the invention.

The damper system (13) is connected to eight different points and provides force against the user's movements in a suitable manner depending on the conditions of a virtual reality environment. However, the magnitude of an applied counterforce can also be adjusted.

The rotary head (14) is a part of which the upper portion is stable and the lower portion is movable and enables the users to turn around their own axis together with the gaming vest (3) worn by the user.

The interconnection element (15) is embedded in the balancing rod (2) and is a part which enables the user to perform various movements such as jumping and bending.

The analogue potentiometer and motion system (16) is a movable analogue sensor system which enables four-direction movements of the balancing rod (2) to which it is coupled to and said movements to be sensed.

The balancing rod (2) is connected to the gaming vest (3) which is worn by the user and allows the users to be able to turn around their own axis at 3600 by balancing them and enabling them to move up and down. Furthermore, the balancing rod (2) can delimit the user movements at a certain range by means of the movement limiting steel ring (11) placed between the outer body (10) and the connection point.

The wall mounting apparatus (7) is a movable part which allows movement up to 360 degrees and also a friction part which can correspond to a wall to which it would be mounted and allows pressing between two walls.

The load drawbar (8) is in a retractable configuration.

The ceiling mounting apparatus (9) is a part which enables the mounting apparatus (1) to be mounted on a ceiling without any need of the wall mounting apparatus (7) and the load drawbar (8).

E. Gaming Vest (3):

The gaming vest (3) or harness is a part which a user can wear and also include a leg belt set (4); may consist of;
A gaming vest electronic circuit and sensor slot (18) containing the sensors and circuit elements which provide all of the body directions of the user to be detected,
Two leg belts (19) which allow the user to sit with the balancing rod (2), which secures the user's upper legs and can take a form such that it can carry the user's weight when the user sits down and
Two leg belt electronic circuits and sensor slots (20) including the sensors and circuit elements which enable the body directions of the user to be detected.

Gaming vest (3) can enable the user to keep his/her balance without restricting the movement abilities of said users and can also prevent them to change their locations in a real environment. While users freely move on the floors (5 or 26), the users can also move in place as if walking, running etc they would not have to actually run in the real world with the help of this gaming vest (3).

F. Motion Floors and Shoes:

Once the users connect themselves to the platform by wearing the gaming vest (3), they should get on a floor on which they can move in a virtual environment but in a real environment they are only allowed to perform dynamic movements on where they are.

This requirement is achieved by two different floors and two different shoes according to an embodiment of the present invention.

A floor used in an embodiment of the present invention is a high friction coefficient smooth and plain floor (5), said floor can be used with an adjustable foot sole (not shown) in a fixable configuration to a shoe with balls (6) or a normal foot sole. Because said foot sole has the very same technical characteristics with the shoe with balls (6), the shoe with balls (6) will be preferred in the description.

Shoe with balls (6) has a plurality of balls (25) on its bottom (23) to enable the user to perform walking and jumping movements in all directions on a high friction coefficient smooth and plain floor (5). Moreover, said shoe with balls may also have a shoe electronic circuit and sensor slot (24) including the sensors and the electronic circuit elements which provide detecting the foot movements in the shoe (6) and measuring the load on the shoe. The aforementioned foot sole has the very same technical features with the shoe with balls (6) and it also has an adjustable configuration which can be subsequently attached to user's shoe.

A floor which is used in another embodiment of the invention is a ball covered floor (26) and has a plurality of floor balls (28) which are located on the bearing balls on the floor and a plurality of micro bearing balls (29). A user can move in any desired direction while wearing any type of shoes by means of the balls (28) on the floor (26) and the micro bearing balls.

The platform according to the present invention which is contemplated to be used in virtual reality technologies is a motion device which can be also called as a motion platform. After the users wear the ball shoe (6) which is specifically designed or a scalable foot sole with which they can also use their shoes, they get on the floor (5) of the platform and wear the gaming vest (3). The platform would be opened once the users complete the dressing process

The gaming vest (3) can keep the user at a balance while connecting them on a wall or a ceiling by means of the balancing rod (2) and the mounting apparatus (1). When the user start to walk or run on the platform, the gaming vest (3) would secure the user and will also prevent them from changing their locations in the real world.

The range of motion of the user in the real world is confined to an approximately 1 m² area as allowed by the motion limiting steel ring (11). In this range, because the user is provided with a high friction between the floor (5) and the shoe (6), they would move in a similar way as that in natural walking sense.

The platform according to the present invention is connected to the virtual reality system in which it is used (A computer, The virtual reality glasses. The game consoles or Smart phones) via wireless technology and it collects the user movements by means of the sensors which are included therein. The sensors are an IMU (Inertial Measurement Unit) sensor, a Bend (BEND) sensor, a Touch (Touch) sensor, a Pressure (Pressure) sensor, an Optical sensor and a Strain gauge (Strain Gauge) and also a potentiometer can be used. The measurements which are received from a plurality of points in the entire system are cleaned by means of noise suppression filters such as Kalman Filter, DeadReckoning and the directions and rates of the body can be detected in the fastest way by using various algorithms in the background. The detected directions and rates are transferred to the receiving platform in a wireless manner and converted into movement within the virtual reality application. All of the process is completed in less than 10 ms.

The damper system (13) which is placed in the mounting apparatus (1) can increase and decrease the tensile depending on the harmony between the used virtual reality application and the platform, thereby the simulation of the user's movements in different conditions such as air, water or rough weather can be performed.

The electronic sensors and circuit components are located in the platform and on the outer body (10), the gaming vest (3), the shoe (6) and the leg belts (19) and are in communication with each other and also they are connected to the virtual reality system in a wired or wireless way.

As long as the motion process of the user is continued, their movements such as walking ahead or back, running, jumping, bending and turning around their own axis at 360 degrees are measured continuously and at very high frequencies and transferred to the system in a wireless manner.

In the operating method of the virtual reality system according to the present invention;
Movement changes at different moments are detected by the IMU, the optical, the touch and the pressure sensors on the shoes (6 and 27), the positions are cleaned by means of various filters and compared with the movements sensed by the other IMU sensors in different points on the feet and the instant changes are transferred to the platform as being movements.
All read sensor values are compared with each other by means of particular algorithm methods and the transition from a moment to another are read at high frequencies, the direction and the manner of the motion is detected and the motion is transferred to the motion platform to which the motion is connected.
The direction to which the body, the legs and the feet are faced are separately transferred to the related application by means of the IMU sensors on the gaming vest (3) and the shoes (6) depending on the capacities of the platform and the software to which the components are connected.
The sensitivity of the damper and the spring system (13) can be adjusted and the movements of the user in different environments can be simulated in relation with the competence of the system and the software to which said component is connected.
The user's movements such as bending and jumping are sensed by the sensors and also transferred as bending and jumping to the platform and the virtual reality application to which they are connected.
The user's movements such as turning around their own axis are transferred to the platform and the application to which they are connected by detecting by means of the IMU sensors at very high frequencies (200 times at second) and accuracies (at a level of sensing a 0.35 degree in 360 degrees).

1. A virtual reality motion platform to provide body movements and directions of a user including walking, running, jumping, and bending, to be transferred to software based simulative environments known as virtual reality, comprising:
a mounting apparatus comprising,
a covered outer body including a balancing rod, a motion limiting steel ring, a damper system connected to eight different points, a rotary head, an interconnection element and an analogous potentiometer and motion system,
a plurality of ceiling mounting apparatuses configured to mount the outer body on a stable structure, a plurality of load drawbars and a plurality of wall mounting apparatuses;
a gaming vest or harness comprising,
a first electronic circuit and/or a first sensor slot including first sensors and first circuit components for detecting the body directions of the user,
two leg belts configured to secure legs of the user and carry weight of the user when the user is in a sitting position; a smooth and plain floor configured to enable the user to perform dynamic movements in a virtual environment corresponding to movements in a real environment;
a shoe including,
a second electronic circuit and a second sensor slot including second sensors and second electronic circuit components cooperating with the smooth and plain floor and detecting feet movements and measuring a load on the feet by a plurality of balls located on a foot sole to enable the user to perform the body movements on the smooth and plain floor.

2. The virtual reality motion platform according to claim 1, wherein, the damper system is a spring damper system.

3. The virtual reality motion platform according to claim 1, wherein, the damper system is a hydraulic damper system.

4. The virtual reality motion platform according to claim 1, wherein, the damper system is configured to increase and decrease a tensile strength of the damper system for applying power against movements of the user in accordance with present conditions in the virtual environment.

5. The virtual reality motion platform according to claim 1, wherein, an upper portion of the rotary head is stable and a lower portion of the rotary head is movable to enable the user to turn around an axis of the user with the gaming vest or harness worn by the user.

6. The virtual reality motion platform according to claim 1, wherein, an interconnection element is embedded in a balancing rod to enable the user to perform movements including jumping, leaning and/or bending over.

7. The virtual reality motion platform according to claim 1, wherein, the analogous potentiometer and motion system provides the balancing rod connected to the analogous potentiometer and motion system to perform a four-direction movement and enables sensing the four-direction movement.

8. The virtual reality motion platform according to claim 1, wherein, the balancing rod is connected to the gaming vest or harness worn by the user and enables the user to be able to turn around an axis of the user at 360° and to move up and down while balancing the user.

9. The virtual reality motion platform according to claim 1, wherein, the balancing rod is configured to delimit the body movements of the user within a certain range by means of a motion limiting steel ring located between the covered outer body and the mounting point.

10. The virtual reality motion platform according to claim 1, one of the plurality of wall mounting apparatuses is a movable part up to 300 degrees and corresponds to a wall on which the one of the plurality of wall mounting apparatuses is configured to be mounted and allows compression between two walls.

11. The virtual reality motion platform according to claim 1, wherein, the plurality of load drawbars are in a retractable configuration.

12. The virtual reality motion platform according to claim 1, wherein, the plurality of ceiling mounting apparatuses are configured to mount the mounting apparatus to a ceiling without any need for a wall mounting apparatus and a load drawbar.

13. The virtual reality motion platform according to claim 1, wherein, is a ball shoe.

14. The virtual reality motion platform according to claim 1, wherein, the shoe is a foot sole configured to be mounted on a user's shoe.

15. The virtual reality motion platform according to claim 1, wherein, the smooth and plain floor is a ball covered floor having a plurality of floor balls located on ball bearings on the smooth and plain floor and a plurality of micro ball bearings.

16. A method for operating the virtual reality motion platform of claim 1,
detecting movement changes at different moments by an IMU sensor on the shoe, comparing the movement changes with sensed movements by other IMU sensors at different points on the feet and transferring the movement changes as movements to a virtual reality environment.

17. The method for operating the virtual reality motion platform according to claim 16, further comprising detecting the movement changes at different moments by optical sensors on the shoe, comparing the movement changes with sensed movements by other optical sensors at different points on the feet and transferring the movement changes as movements to the virtual reality environment.

18. The method for operating the virtual reality motion platform according to claim 16, further comprising predicting a position of a foot depending on load changes at different moments sensed by touch and pressure sensors on the shoe; comparing said position with other touch and pressure sensors on an other foot and transferring the load changes as movements to the virtual reality environment.

19. The virtual reality motion platform according to claim 16, further comprising comparing all read sensor values with each other by means of predetermined algorithm methods, detecting a direction and a manner of the movement by reading transition from a first moment to another at high frequency and transferring the movement to the motion platform.

20. The method for operating the virtual reality motion platform according to claim 16, further comprising transferring separately facing directions of the body, the legs and the feet of the user in relation to an application by means of the IMU sensors on the gaming vest and the shoe depending on capacities of the virtual reality motion platform and a software to which the components are connected.

21. The method for operating the virtual reality motion platform according to claim 20, further comprising adjusting a sensitivity of the damper or spring system and simulating the movement of the user in different environments in relation with the virtual reality motion platform and the software.

22. The method for operating the virtual reality motion platform according to claim 16, further comprising sensing the movements of the user including bending and jumping by the sensors and transferring said movements as corresponding bending and jumping movements to the virtual reality motion platform and a virtual reality application connected to the virtual reality motion platform.

23. The method for operating the virtual reality motion platform according to claim 16, further comprising detecting the movements of the user including turning around the user's own axis by means of the IMU sensors at a rate of 200 times per second and a sensing accuracy of 0.35 degree in 360 degrees and transferring to the virtual reality motion platform and an application connected to the virtual reality motion platform
